(19) United States
(12) Patent Application Publication
(10) Pub. No.: US 2004/0254913 A1
(43) Pub. Date: Dec. 16, 2004

(54) System, method and apparatus for navigating and selectively pre-caching data from a heterarchical network of databases

(76) Inventors: David Bernstein, Seattle, WA (US); Richard Buff, Woodstock, GA (US)

Correspondence Address: David Bernstein, 1308 NW 70th Street, Seattle, WA, 98117, US

(21) Appl. No.: 10/323,717

(22) Filed: Dec. 18, 2002

Related U.S. Application Data
(63) Continuation of application No. 09/239,906, filed on Jan. 29, 1999, now abandoned.
(60) Provisional application No. 60/073,111, filed on Jan. 30, 1998.

(51) Int. Cl. G06F 7/00

(52) U.S. Cl. 707/2

(57) ABSTRACT

An improved method for navigating links in a heterarchical database such as the World Wide Web that operates stand-alone, apart from a conventional browser or as a sidebar window in conjunction with a conventional browser, allowing links to be collected, displaying a list of collected links and optionally pre-caching them in real time. Links are displayed along with a download status indicator in a selectable list or hierarchical tree structure. When a link in the list is selected the corresponding page is navigated to and displayed in a conventional browser.

This is a Continuation of patent application Ser. No. 09/239,906 filed Jan. 29, 1999, which claims priority to provisional patent application 60/073,111 filed Jan. 30, 1998, entitled “Method and apparatus for navigating and selectively pre-caching data from a heterarchical network of databases”.

### TECHNICAL FIELD

The invention relates to system, method and apparatus for navigating and selectively pre-caching data from a heterarchical network of databases; more particularly, it relates to system, method and apparatus for navigating a system of linked data sources, such as the Internet, in conjunction with a conventional browser, to speed access and efficiency in retrieving and viewing data from those sources.

### BACKGROUND OF THE INVENTION

Computer networks are generally organized so that each computer has zero or more links to other computers. Moreover, computer networks are not the only forms of heterarchical database networks. “Heterarchical” means, at the least, non hierarchical; it also means generally that the network is arranged without regard to any externally imposed ordering scheme. Other such networks of databases might be found in online help manuals, and series of such help systems, and in business information and filing systems on computer, particularly if they are hyperlinked in some way.

Internet browsers allow users to travel through these networks of computers by having the user click on a link listed on a page to take them to another page, a page that could be on the same computer, or located on a different computer half way around the world. There is currently no option though; if you click on a link on a page displayed, for example by Internet Explorer or by Netscape Navigator, then you go directly to the linked page (or program or graphical file, etc). Many Web pages contain a list of several links that could be of interest to the user, but many surfers never find their way back to that page, or for that matter, to any other page containing multiple links of possible interest!

The problem then is that, because the normal behavior of a Web browser is to immediately load a new page when a link is selected, in order to get to another link on the original page the user must back track to the original page first before exploring the next link. The number of times the user must go back to the “starting” page is equal to the number of links on that page that the user wishes to visit.

Another inherent problem is that a browser is basically just a retrieval mechanism and a viewer; it is not an especially good navigator. Any ‘navigation’ it appears to be doing is passive; it is driven by the user who is at all times at least partially blind as to the sites or pages she may want to visit. What is needed is a more active form of navigation; one which is “driven” by full visualization of all the interestingly possible pages available, so that any page can be retrieved without getting lost in the maze of the network.

To better understand this situation visualize the relationship between Web pages as a tree structure. To visit each node on the tree, the number of times each node must be visited is equal to the nodes to visit directly below the node in question plus one. For example, to travel through a binary tree requires N*3 visits to all nodes, to travel through a ternary tree requires N*4 visits, and so on.

Known browsing accelerator add-ins primarily rely on two models: they either indiscriminately download every link on a page, or selectively download all the links that have been previously visited by the user. Neither of these approaches seems to have addressed the real concerns of most net users. One reported browser appears to have the capability of downloading links in the background, but it does so in a full browser product and has no apparent means for use with an existing top of the line browser; it cannot work with any other browser, or any other data navigating and viewing system.

The two most common complaints that users have when surfing the Internet is that accessing pages can be slow and that it is difficult getting back to a previously viewed page. The invention directly addresses both of these complaints. What is needed is a Web browser add-in or plug-in that helps to surf the Web faster and more efficiently, so as to double, triple or quadruple the number of web sites that can be visited in a particular amount of time, and that is software implemented to avoid adding any additional hardware.

### DISCLOSURE OF THE INVENTION

Accordingly, it is an object of the invention to provide a more active form of navigation; one which is “driven” by full visualization of all the possibly interesting sites or pages available, so that any page can be retrieved without getting lost in the maze of the network.

It is a further object of the invention to provide a Web browser add-in or plug-in that helps to surf the Web faster and more efficiently, so as to double, triple or quadruple the number of web sites that can be visited in a particular amount of time, and that is software implemented to avoid adding any additional hardware.

It is also an object of the invention to provide a drag and drop interface between a browser window displaying page data including URLs, and a catcher list for receiving the dropped URLs.

It is a further object of the invention to provide an optionally multithreaded download process for parsing and downloading page data associated with URL's dropped on the catcher list to a data storage or cache for later selected retrieval and display of such page data in the browser window.

It is yet another object of the invention to meet any or all of the needs summarized above.

These and such other objects of the invention as will become evident from the disclosure below are met by the invention disclosed herein.

The invention addresses and provides such a system. The invention provides a more active form of navigation; one which is “driven” by full visualization of all the possibly interesting pages available, so that any page can be retrieved without getting lost in the maze of the network. It also provides a Web browser add-in that helps to surf the Web faster and more efficiently, so as to accelerate the speed with which a number of web sites can be visited. All of this is hardware independent and is software implemented. In general throughout this disclosure the terms “URL” or “link” are used in the sense of a ‘pointer’ or locator or “HREF” for database data, such as the location of an HTML page on the web. The term “URL page data” or the like is used in the sense of page ‘content’; that is, the data at the specified URL location. Those skilled in the art will appreciate that such page data can include graphical file references, text, HTML mark up info, other URLs, ActiveX controls and other page display data.

In one embodiment of the invention, a method is provided for using a computer system for aiding a user in navigating a heterarchical database using a conventional browser or other content viewer, the method preferably operating independent of the browser and comprising the following steps:

a. catching, intercepting, collecting and/or storing URLs from hyper-links and other sources;

b. pre-caching, or downloading, in memory or local storage media, synchronously or asynchronously, page data from the intercepted, collected or stored URLs before the user has requested display of the URL page data (however, optionally in some embodiments, this pre-caching step may be selectably deferred);

c. displaying the pre-cached URL page data using a conventional browser.

In another embodiment of the invention, a method is provided for using a computer system for aiding a user in navigating a heterarchical database using a conventional browser or other viewer, where the method may either operate independently of the browser or optionally may be integrated with the browser, the method comprising the following steps:

a. catching, intercepting, collecting and/or storing URLs from hyper-links and other sources and adding them to a displayed list;

b. optionally pre-caching, in memory or local storage media, immediately or at a later time, page data from the collected URLs;

c. selecting a URL from the list of the collected URLs, and then displaying the page data from the selected URL using the conventional browser or other viewer.

In this method, the step of pre-caching URL page data may optionally begin immediately upon adding the URL to the displayed list, and the display list may optionally be in the form of a hierarchical tree. The method may also further comprise the step of graphically displaying a download status of the page data for the collected URL in close proximity in the list to the display of the URL itself.

In this method the step of catching, intercepting, collecting or storing URLs from hyper-links and other sources and adding them to a displayed list is accomplished with “drag and drop” functionality, or alternatively with convention “cut and paste” functionality.

Another embodiment of the invention is an apparatus for aiding a user in navigating a heterarchical database, the apparatus comprising:

a. a computer operatively connected to the heterarchical database, and a browser resident on the computer for displaying page data such as URLs, graphics, text and the like from a source, such as a Web page, that is part of the heterarchical database;

b. a URL catcher, preferably software implemented, and operatively resident in the computer and having a URL list operatively associated therewith, the list displayable on the computer;

c. a data storage, preferably non-volatile computer memory, operatively associated with the computer for holding URL page data associated with a particular selected URL, the storage either resident on the computer or remote and connected operably to the computer;

d. a selector, preferably software implemented, and operatively associated with the computer (and preferably with a pointing device operably associated with the computer) and with the URL list, whereby selection of a particular URL from the list displays that URL's page data on the computer by way of the browser.

This apparatus may advantageously also comprise a parser/downloader, preferably software implemented, and operatively associated with the URL catcher and URL list for parsing and downloading selected URL page data from the URL to the data storage. The user of the apparatus may thus optionally preselect which page data elements are to be downloaded.

The invention thus involves a new method of navigating and optionally pre-caching links from any heterarchical database or network of computers. One application for this invention is to help people better browse the World Wide Web. This invention is described here as an “add-in” that works with a conventional browser such as Microsoft Internet Explorer or Netscape Navigator, in other words, this invention is not intended to replace the features of a conventional browser but rather to augment them.

Unlike other browsers with add-in accelerators and the like, that try to guess what links the user wants to see next, or just blindly download every link on the page, the invention stores selected URLs, and optionally downloads and caches only the pages for the links selected by the user as being of possible interest, making much more efficient use of the user's internet connection.

This invention provides a means for visiting all nodes in a tree by visiting each node only once. The invention may be applied to many different kinds of computer data structures; in particular it may be applied to enhance the experience of navigating the World Wide Web.

The invention, sometimes referred to as MicroSurfer, embodies a much better way of navigating and accelerating access to the World Wide Web than conventional browsing. Instead of clicking on a link and waiting for the page to load, the user drags and drops links from their browser onto the MicroSurfer window and the pages are selectively or automatically downloaded to the user's local hard drive in the background. This allows the user to select or preselect more than one link to visit on a page without ever being required to go back to that page just to review the potentially interesting links previously seen. It also provides for viewing pages faster since they are likely to be downloaded when the user is ready to see them, thus taking advantage of the phenomenon that there is generally no downloading going on at a user's machine while the user is reading the page conventionally. With the invention, that idle time is put to use downloading pages selected by the user. Thus it becomes possible for even the slower modems today to access web info as if they were a high speed line!

In accordance with one aspect of the invention, conventionally gathered link lists, such as “favorites” or “hot (or cool) sites” lists or bookmark lists can themselves be dropped onto the sidebar window of the invention and thus all be downloaded in the background. This is in distinction to the conventional functionality of such lists, which do permit one click navigation to selected sites, but they can not cache in the background, either singly or in multiples of links, as can the invention. Also, such lists are relatively permanent lists (subject to editing), while the catcher list of the invention can selectably be a temporary list.

With the invention, the user can drag and drop as many links as they want from a page or list to be downloaded and then step through each link without having to return to the previous page. This is a fundamental shift in the way people browse the Internet.

The invention is disclosed in several aspects:

1. A method of pre-selecting one or more Web pages from the same page to be viewed later without having to go back to the original page.

2. The selective ability to download into a cache, pre-selected Web pages. Users select pages to pre-cache by dragging and dropping (or optionally hot-keying) links onto a sticky links list. This causes the page, and selected of its components, to be downloaded in the background if pre-caching is enabled.

3. Multiple downloading of more than one page at a time to speed up throughput.

4. Optionally automatically suspending background navigation when the user navigates in the main browser to increase user response time.

5. Providing optional audio/visual cues to the real time state of the link—i.e. queued, downloading, ready, viewed.

5. Drag and drop Web pages, FTP files, Favorites or shortcuts.

6. AutoPlay—this is a One Button Interface that scrolls through an optionally pre-cached Web page until it reaches the bottom and then selectably automatically goes to the top of the next Web page in the list. Users can single click the AutoPlay button to go forward one page at a time or they can click and drag to “shuttle” multiple pages forward or back at variable speeds.

7. ReSite Maps—When a new Web site is encountered MicroSurfer will optionally and selectably automatically go to the topmost page of the site and search through all referenced pages to construct a hierarchical diagram of the site, allowing users to navigate directly by clicking on nodes in the diagram.

It should be pointed out that in the invention pre-caching is selectably optional, though typically preferred, and is just one of the advantages of this method of link selection. Just as important is the ability for users to select multiple links on the same page without having to visit each one and then go back to the original page to visit the next one.

Another aspect of the invention is that it uses multiple threads to download from several URL's at the same time. This increases the throughput considerably. The way it does this is that it parses the HTML file and creates a list of all elements that need to be downloaded. Some or all of the page elements can be deselected for downloading.

Still another aspect of the invention is how to view the links once downloaded. The invention displays a list of all downloaded links. The user may click on the link to view it or they may step through each link by using the next and previous buttons. Because it is possible in some embodiments to download links directly into the browser cache, users can also get the speed benefit of loading pre-cached links into this browser whenever they select those links in their browser (as long as the browser is configured to use caching), not just when they click such a link in the MicroSurfer window. The cache may be configured by the amount of memory or local storage media to be reserved for URL page data. The invention may be configured as well with reference to the number of pages to be simultaneously downloaded. The user may optionally view with the browser any link on the list of downloaded links either online or offline.

Perhaps the most unique method of viewing links is the AutoPlay feature. This ergonomic feature saves users from having to move the mouse all around the screen to view a list of one or more documents. AutoPlay will work with virtually any program that contains a window with scrollbars.

AutoPlay has two modes: normal and shuttle. In normal mode, the user clicks the AutoPlay button to page down through the document. At the last page of the document clicking AutoPlay causes the next document in the list to be loaded and the first page of that document to be displayed. If the user is working with a single document instead of a list of documents, clicking AutoPlay on the last page of the document causes it to jump to the first page (top) of the document.

In shuttle mode AutoPlay acts like the shuttle control on a VCR. Clicking and dragging the AutoPlay button to the left or down causes AutoPlay to send page down messages to the scrollbars at a set interval. The interval is decreased so that pages are displayed faster the further left or down the user drags. The interval is increased so that pages are displayed slower the further right or up the user drags. When the user drags right or up past the midpoint of where they started dragging, AutoPlay sends page up messages to the scrollbars. Both distance and velocity of dragging is used to determine the rate of scrolling so as to have a more natural feel for the user.

Since the AutoPlay feature can work with any window that contains scrollbars, it can be viewed as a separate feature apart from the rest of the invention or as an integral part of it.

### BRIEF DESCRIPTION OF THE DRAWINGS

FIG. 1 is a schematic block form flow chart of the user selection operation of the invention.

FIG. 2 is a schematic block form flow chart of the download/parser thread operation of the invention.

FIG. 3 is a schematic block form flow chart of the user navigation operation of the invention.

FIG. 4 is a schematic block form flow chart of the ReSite flow operation of the invention.

### BEST MODE OF CARRYING OUT THE INVENTION

Turning now to the drawings, the invention will be described in a preferred embodiment by reference to the numerals of the drawing figures wherein like numbers indicate like parts.

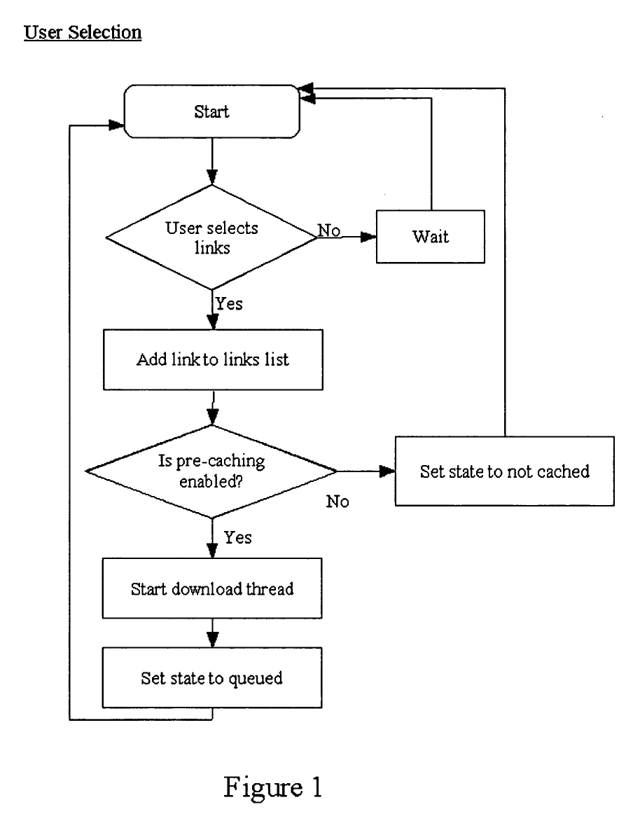

FIGS. 1-4 are flow charts of aspects of the programmatic aspects of the invention. In FIG. 1, at the start, the user selects a link (hyperlink, URL or the like) visible on a browser displayed page. If there are no links selected, the program waits. Once a link is selected (i.e. by drag and drop onto the sidebar link list window), it is added to the list. There is a check of the system to see if pre-caching has been enabled (if it is not, then the user selection flow and list creation stops with assembly of the list —no downloading), and if it is, then a download thread is started for the link, and the link state is set to “queued”. There is then a recheck for additional links that may have been selected and the process cycles until no more links are selected.

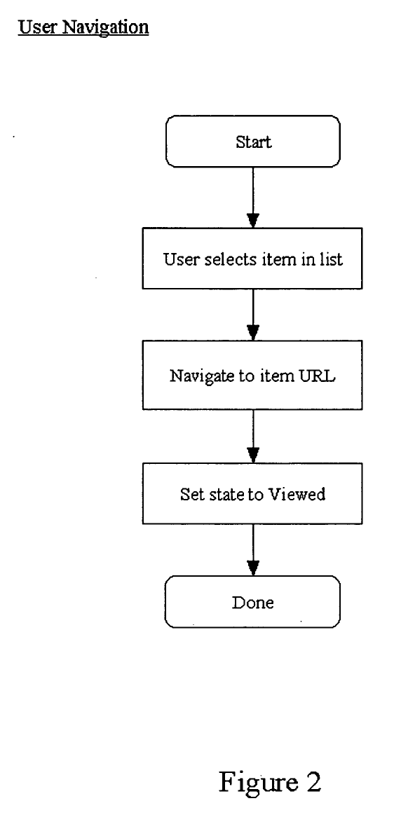

In FIG. 2, at the start of the download thread, the link or URL is downloaded to the preconfigured cache file on the user's computer, and parsing of the URL page data is then begun, and the link state is set to “downloading”. For each element found on the page, there is a check to see if the element is of a type preselected as downloadable (and if not, the element is skipped and the next element is examined), and optionally to see if the foreground browser is busy. If the browser is busy, the whole background process selectably waits. If it is not busy, then the element is downloaded. If there are more elements on the page, that portion of the process cycles until there are none. Then the link state is set to “downloaded” or “ready”, and the thread ends.

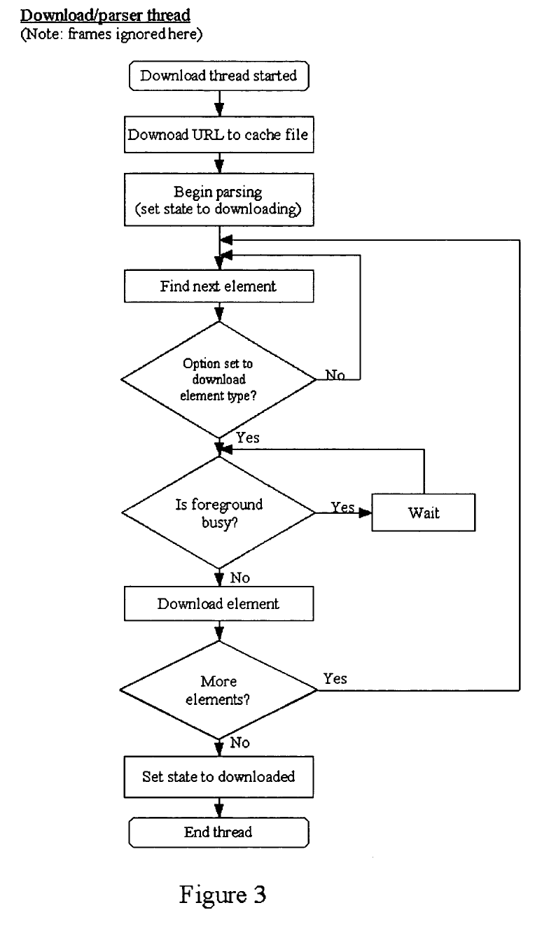

In FIG. 3, for user navigation of the link list, at the start the user selects a link in the links list. The browser then displays that link (URL page data, etc), and the link state is set to “viewed”.

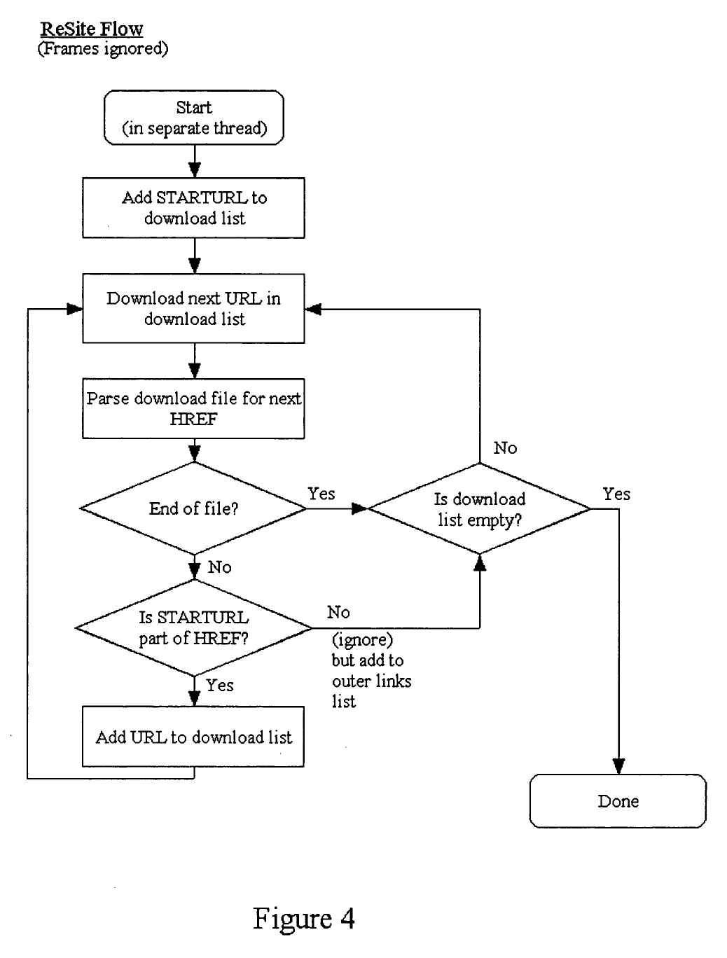

In FIG. 4, for ReSite flow, it starts with a URL in a separate thread, a STARTURL is added to the download list, and the next URL in the download list is downloaded. The downloaded file is then parsed for the next HREF. If there is none, or the end of file is reached, and if the download list is empty, the ReSite data collection is complete. The data may be employed to build a site map or outline by well known methods. If the download list is not empty, then the next URL is downloaded. At this point, and until the last HREF has been processed, it is determined whether the STARTURL is part of the HREF; if not, it is ignored but added to the outer links list and the download list is checked to see if it is empty, as before. If the STARTURL is part of the HREF, then the URL is added to the download list, and the next URL in the download list is retrieved.

Implementation

The invention is implemented allowing the user to select links for download by intercepting the link when the user clicks for navigation, or by drag and drop. Intercepting links during navigation is accomplished via a technique known as event sinking through connection points in OLE. OLE objects such as Microsoft's Internet Explorer WebBrowserObject allow the interception of links using the BeforeNavigate event. Link selection can alternatively be implemented via drag and drop which is highly standardized in the industry and works on multiple browsers. MicroSurfer alternatively employs an ActiveX explorer bar that preferably integrates into Microsoft Internet Explorer 4.0.

Background downloading involves several steps. First, the HTML page is downloaded (HTML is used as an example but the prototype works for FTP, shortcuts and virtually any other object that supports drag and drop and contains a file as a target). Once the HTML page is downloaded (which is done in a separate thread), it is parsed and for each page component that is external (such as images, sounds, ActiveX controls, applets, embedded objects, scripts, etc.), each one is downloaded individually. When permitted by the browser, downloads go directly to the browser's cache (or optionally to a private cache, with redirection of the browser to look in the private cache first) so that whenever the user browses to that same URL the browser automatically retrieves it from the cache (browser's or private) instead of from the network. This usually involves having the user set the browser to look in the cache first, an option in most browsers.

Since each HTML file and all it's components are downloaded in their own thread, multiple downloads can occur at the same time. Even on a 28.8 K modem connection, six simultaneous download sessions can greatly improve performance over downloading one page at a time. This is because multiple download threads can make use of the idle time when one server is not transferring data so that another server can. As we are downloading we optionally check to see if the main browser is busy and if so that means the user is trying to directly navigate to a link so we can selectably suspend background navigation so that the user has full access to the total bandwidth of the connection.

Once a page is downloaded it can be displayed from the local cache by either selecting from the “links list”, pressing the “next page” button or, because the browser recognizes that the page is in the cache, when ever the user selects the URL in their browser.

ReSite

The ReSite feature basically looks at the URL of a link, finds the root address (the link's home page), loads the HTML for the root address and then parses all the links on that page for other URL's that are off the root address. This is done for each link so that a tree is built with the root address at the top and all the pages off of the root address are below. Each node in the tree represents a page on the site and users can go directly to the page by clicking on the node.

ReSite is a graphical navigation tool that dynamically builds active maps of Web site's structures and displays them in a tree view window. Given a URL, ReSite will download and parse the page for all of the HREF tags. ReSite distinguishes between HREF URL's that begin with the original URL that was passed in, and which are part of the same site (inner links), and HREF URL's that are not part of the original site (outer links). (URL's of FRAME and IFRAME tags are treated the same as HREF tags and classified as inner or outer links based on whether the original URL is part of it's URL, or not.) This process is repeated for each inner link found, and a tree is built showing the hierarchical relationship of inner links. At the same time ReSite builds a list of outer links. The user can see a list of outer links for each page or a list of Web sites referenced anywhere throughout all the inner links.

Since in the ReSite embodiment, only HTML is downloaded and not embedded objects, images, applets, etc. this process is fast. The tree is then displayed in a tree view control where each node displays the page title and optionally other information such as the size, number of images, applets, etc. Users can click on any node to automatically navigate to that URL They can also select a node or entire branch of the tree to be fully downloaded (including embedded reference objects) immediately or at a later time. Thus, the ReSite control can be used for navigation or site selection for further action.

An example tree of inner links is shown below:

Magic Baby Home Page (www.magicbaby.com)

MicroSurfer (www.magicbaby.com/microsurfer)

More Information (www.magicbaby.com/microsurfer/moreinfo)

How It Works (www.magicbaby.com/microsurfer/howit)

Downloads (www.magicbaby.com/microsurfer/download)

Buy It (www.magicbaby.com/microsurfer/download/buyit)

Support (www.magicbaby.com/microsurfer/support)

Online Support Center

(www.magicbaby.com/microsurfer/support/osc)

The URL's above are for illustration purposes and may not actually be displayed in the tree view. Users may use the ReSite map to find pages of interest without having to visit (fully download) lots of pages and then click on a node in the tree to navigate directly to the page.

ReSite has several advantages over Site Maps which are static and must be set up by the Web page designer. The ReSite control is not part of the Web site but rather a navigation tool that runs against Web sites and provides better visualization and navigation abilities.

The ReSite map making process can further be sped up by having a server process requests. In this model the software running on the user's local machine would make a request to one of our servers (which have high speed connections to the Internet) to build a ReSite map at high speeds and then pass the results back to the user's local machine. In the event that the server was unavailable, a ReSite map would be built on the user's machine locally. By combining client software with software running on our servers the user can get a performance boost and other benefits. This is a valuable service to the client.

The unique features to this tool are:

Iteratively or recursively build hierarchical tree of Web site structure dynamically and on-the-fly.

Shows the relationships between pages within a site and pages across sites.

Builds ReSite maps quickly since it doesn't download embedded objects, applets, image files, etc.

Quickly navigate to any page by clicking on the node in the tree view.

Optional server software that can build ReSite maps for clients faster.

AutoPlay

The AutoPlay feature (also called the Shuttle) allows the user to go through all the pages in a list of files by pressing one button. This feature can work with most windows that contain scrollbars via a system hook procedure. Each time the button is pressed it sends a page down message to the window and then queries the window to see if it is on the last page of the document. If it is the last page AutoPlay automatically loads the first page of the next document. This saves the user from a great deal of mousing around the screen. AutoPlay also works like a shuttle control on a VCR. Clicking and dragging the AutoPlay button to the right or down causes the window to page down at regular intervals such that the further the drag the faster the paging. Clicking and dragging to the right slows the page down and once the midpoint is crossed causes the window to receive page up messages.

The AutoPlay Shuttle is an information delivery tool designed to work with a Web browser such as Microsoft's Internet Explorer but that can work with virtually any application that contains a window with scrollbars. This ergonomic tool provides a convenient way to scroll within and across documents.

The AutoPlay Shuttle control may present itself as a fixed dialog tool palette or may float with the mouse pointer and pop up on a click, like a context menu.

Clicking the AutoPlay button causes the currently selected window to page down. This is done by one of two methods: either sending a page down (or page up) message to the window or by using a system hook to pass the message. Then AutoPlay sends a message to the scrollbar to find out if it at the bottom of the document and, if so, it either loads the next document, goes to the top of the current document or stops.

AutoPlay can also operate in a Shuttle mode which is similar to the shuttle control on a VCR. By clicking and dragging the AutoPlay button to the right or down, users can begin paging down at an interval set by the velocity and distance that the user dragged. The further and faster to the right the user drags, the faster pages are scrolled. Dragging left or up slows scrolling until the point the user started is reached when scrolling stops. Dragging further and faster left or down causes scrolling to page up.

AutoPlay Key Features

Works with virtually any window containing scrollbars.

When end of document is reached it automatically loads the next document in the list or goes back up to the top (or stops).

Shuttle feature lets you click and drag to scroll on a timer at set intervals.

Shuttle intervals are adjusted by velocity and distance of dragging (using linear and/or logarithmic scales).

Description of Program Flow

The following is a high level description of one embodiment of the MicroSurfer program invention. It should be noted that there are several ways to implement the invention and several methods have been tried successfully. This description relies on common components readily available from the Microsoft Internet Client SDK (Software Development Kit) and some of the terminology used is part of that SDK. This was selected because it is believed to be currently the most robust object model for a browser; however the same invention could be implemented in Java or another programming language on any of several browsers.

MicroSurfer can be implemented as a browser add-in Explorer Bar that can easily be extended to exist inside of it's own HTML frame on a browser page or in a separate window resembling a remote control as a separate executable process.

When the user drops a link onto the invention's MicroSurfer window, a thread is created and that link is downloaded using a stream moniker into an HTML object. This HTML object is then parsed for the following elements: images, applets, scripts, ActiveX and other embedded objects which may be each be optionally and selectably downloaded in the background as well.

Because this process of downloading and parsing happens in a separate thread, multiple links may be downloaded at the same time. When links are dropped they are displayed in a list view. For each link dropped the user is given visual queues (such as a colored icon next to the link in the list) that show if the link is queued for downloading, currently being downloaded, downloaded but not yet viewed, downloaded and viewed or in an error state.

The user can instantly display downloaded links by simply clicking on a link, clicking the next page, previous page or AutoPlay buttons. Links are displayed by causing the browser to navigate to that link. Whenever links are downloaded directly into the browser's cache, displaying links by the browser is immediate.

Users can load and save list(s) of links; saving a link list produces a new HTML file with all of the links as HREFs, and additional info may be stored in proprietary tags.

It is believed that those familiar with Windows, ActiveX and OLE will be able to fit these components together as described without additional instruction. When these components are combined together they produce a very useful tool that offers some clear advantages over conventional browsing.

This invention can also be applied to building lists from other sources such as “shortcuts”, online help systems and other hyper-link systems. Even in situations where pre-caching is not necessary such as with a fast connection to the server or when the data is already on the user's machine, there is still the benefit of the new total visualization browsing paradigm (multiple links selected from the same page), with a visually cued navigation list compilation rather than the “Back” button.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. In a computer system, a method for aiding a user in navigating a heterarchical database using a conventional browser, the method operating independent of the browser, comprising the following steps:
a. catching, intercepting, collecting or storing URLs from hyper-links and other sources;
b. pre-caching or downloading, in memory or local storage media, synchronously or asynchronously, page data from the URLs before the user has requested display of the URL page data;
c. displaying the pre-cached URL page data using a conventional browser.

2. In a computer system, a method for aiding a user in navigating a heterarchical database using a conventional browser or other viewer, comprising the following steps:
a. catching, intercepting, collecting or storing URLs from hyper-links and other sources and adding them to a displayed list;
b. optionally pre-caching, in memory or local storage media, immediately or at a later time, page data from the collected URLs;
c. selecting a URL from the list of the collected URLs, and then displaying the page data from the selected URL using the conventional browser or other viewer.

3. An apparatus for aiding a user in navigating a heterarchical database, the apparatus comprising:
a. a computer operatively connected to the heterarchical database, and a browser resident on the computer for displaying page data such as URLs, graphics, text and the like from a source that is part of the heterarchical database;
b. a URL catcher operatively resident in the computer and having a URL list operatively associated therewith, the list displayable on the computer;
c. a storage operatively associated with the computer for holding URL page data associated with a particular selected URL;
d. a selector operatively associated with the computer and with the URL list, whereby selection of a particular URL from the list displays that URL's page data on the computer by way of the browser.

4. The apparatus of claim 3 further comprising a parser/downloader operatively associated with the URL catcher and URL list for parsing and downloading selected URL page data from the URL to the storage.

5. The method of claim 2 wherein the step of pre-caching URL page data begins immediately upon adding the URL to the displayed list.

6. The method of claim 5 wherein the display list is in the form of a hierarchical tree.

7. The method of claim 5 further comprising the step of graphically displaying a download status of the page data for the collected URL in close proximity in the list to the display of the URL itself.

8. The method of claim 2 wherein the step of catching, intercepting, collecting or storing URLs from hyper-links and other sources and adding them to a displayed list is accomplished with “drag and drop” functionality.
